(19) United States
(12) Patent Application Publication
(10) Pub. No.: US 2016/0342800 A1
(43) Pub. Date: Nov. 24, 2016

(54) ELECTRONIC DEVICE AND HARD DISK DEVICE OF ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: SONG MA, Shenzhen (CN); CHENG-FEI WENG, Shenzhen (CN)

(21) Appl. No.: 14/754,035

(22) Filed: Jun. 29, 2015

(30) Foreign Application Priority Data
May 19, 2015 (CN) 201510255068.9

(51) Int. Cl. G06F 21/62; G06F 21/60; G06F 1/26; H04L 9/08

(52) U.S. Cl. CPC G06F 21/62; H04L 9/0863; G06F 21/602; G06F 1/266

(57) ABSTRACT

A hard disk device includes a storage module, a control chip, an encryption chip, and a power switching module to power the storage module. The control chip controls a display interface to prompt a user to enter a password, and outputs the password to the encryption chip, when a central processing unit accesses the storage module through the control chip. The password is encrypted to generate an encrypted password by the encryption chip, and the encryption chip transfers the encrypted password to the control chip. The control chip sets a first received encrypted password as a reference password. When the control chip determines that a number of subsequent continuously received encrypted passwords are different from the reference password, the control chip controls the power switching module not to power the storage module.

### FIELD

The subject matter herein generally relates to electronic devices, and particularly to an electronic device with a hard disk device.

### BACKGROUND

An electronic device can be configured to store data. The data can be stored on a hard drive. In some electronic devices, a plurality of hard drives can be included. In one embodiment, the plurality of hard disk devices is installed in the electronic device for storing data.

### BRIEF DESCRIPTION OF THE DRAWINGS

Implementations of the present technology will now be described, by way of example only, with reference to the attached figures.

FIG. 1 is a block diagram of an embodiment of an electronic device, wherein the electronic device comprises a hard disk device and a display device.

FIG. 2 is a block diagram of the hard disk device of FIG. 1, wherein the hard disk device comprises a power switching module, a power shielding module, and a display module.

FIG. 3 is a block diagram of the display device of FIG. 1.

FIG. 4 is a circuit diagram of the power switching module of FIG. 2.

FIG. 5 is a circuit diagram of the power shielding module of FIG. 2.

FIG. 6 is a circuit diagram of the display module of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising” means “including, but not necessarily limited to”; it specifically indicates open-ended inclusion or membership in a so-described combination, group, series and the like.

The present disclosure is described in relation to an electronic device.

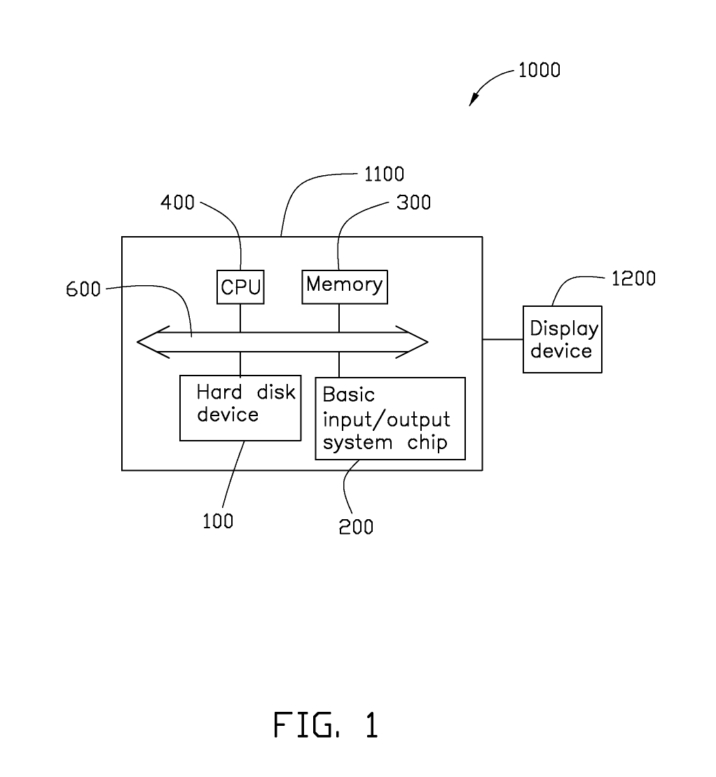

FIG. 1 illustrates an electronic device 1000. The electronic device 1000 comprises a main board 1100 and a display device 1200 electrically coupled to the main board 1100. The main board 1100 comprises a hard disk device 100, a basic input output system (BIOS) chip 200, a memory 300, a central processing unit (CPU) 400, and a bus 600. The hard disk device 100, the BIOS chip 200, the memory 300, and the CPU 400 are electrically coupled to the bus 600, and communicate with each other through the bus 600. In at least one embodiment, the electronic device 1000 can be a computer or a server.

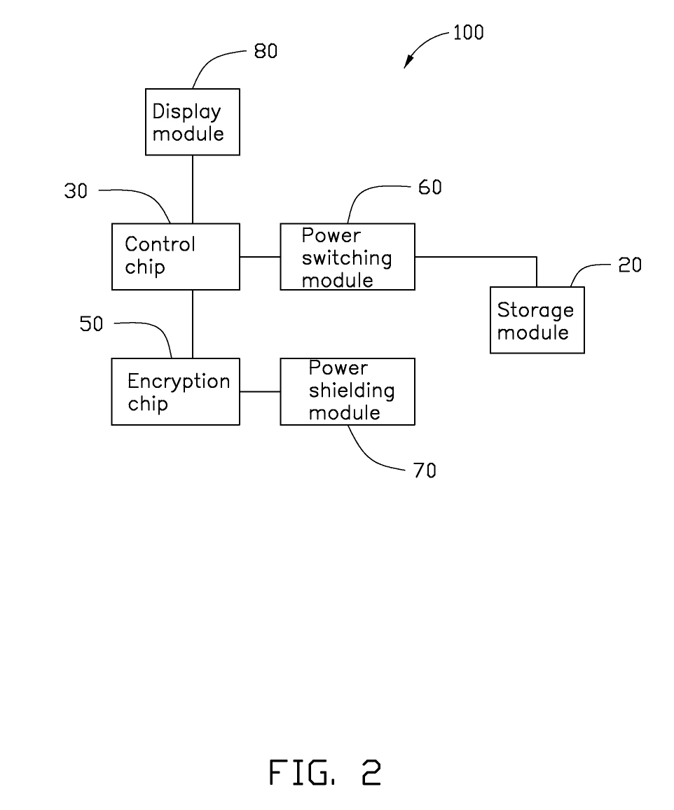

FIG. 2 illustrates an embodiment of the hard disk device 100. The hard disk device 100 comprises a storage module 20, a control chip 30, an encryption chip 50, a power switching module 60, a shielding module 70, and a display module 80. The control chip 30 is electrically coupled to the encryption chip 50 and the display module 80, and further electrically coupled to the storage module 20 through the power switching module 60. The shielding module 70 is electrically coupled to the encryption chip 50.

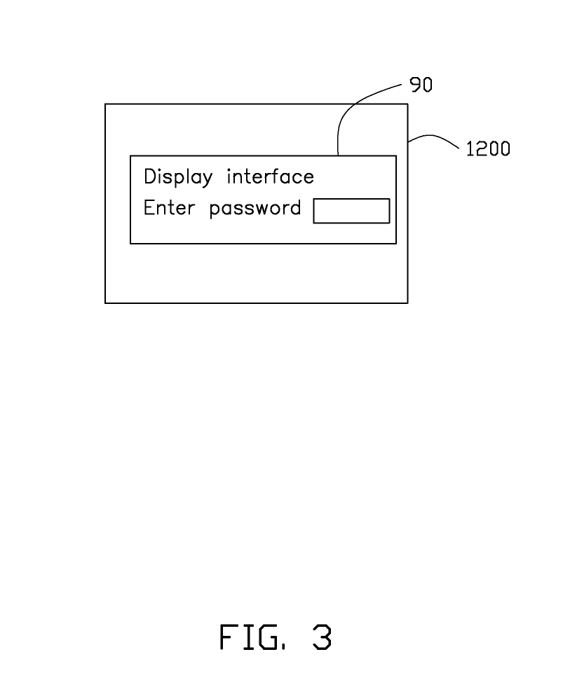

FIG. 3 illustrates an embodiment of the display device 1200. The display device 1200 is configured to display a display interface 90.

In at least one embodiment, the power switching module 60 is configured to power the storage module 20. The storage module 20 is configured to store data. The control chip 30 is configured to control the display device 1200 showing the display interface 90 to prompt the user to enter a first password, when the CPU 400 accesses the storage module 20 through the control chip 30. The control chip 30 is further configured to transfer the first password to the encryption chip 50. The encryption chip 50 is configured to encrypt the first password to generate an encrypted password, and transfer the encrypted password to the control chip 30. The control chip 30 is configured to set a first received encrypted password as a reference password, and save the reference password. The control chip 30 is further configured to determine whether subsequent received encryption passwords are the same as the reference password. When the control chip 30 determines that a plurality of subsequent continuously received encryption passwords are different from the reference password, the control chip 30 controls the power switching module 60 not to power the storage module 20. The control chip 30 is further configured to control the display module 80 to indicate whether the hard disk device 100 is encrypted. The shielding module 70 is configured to control the encryption chip 50 not to work, to shield encryption function of the hard disk device 100.

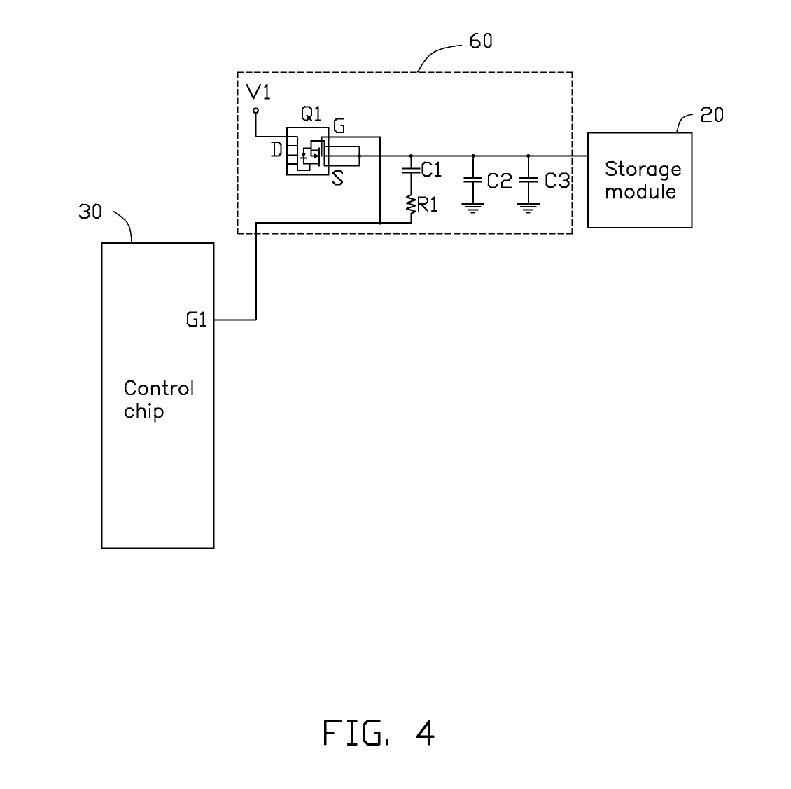

FIG. 4 illustrates an embodiment of the power switching module 60. The control chip 30 comprises a first pin G1. The power switching module 60 comprises a first electronic switch Q1, a resistor R1, and three capacitors C1, C2, and C3. The first electronic switch Q1 comprises a first terminal G electrically coupled to the first pin G1 of the control chip 30, a second terminal D electrically coupled to a first power supply V1, and a third terminal S electrically coupled to the storage module 20. The third terminal S is further electrically coupled to the first pin G1 through the capacitor C1 and the resistor R1, electrically coupled to a ground through the capacitor C2, and electrically coupled to the ground through the capacitor C3.

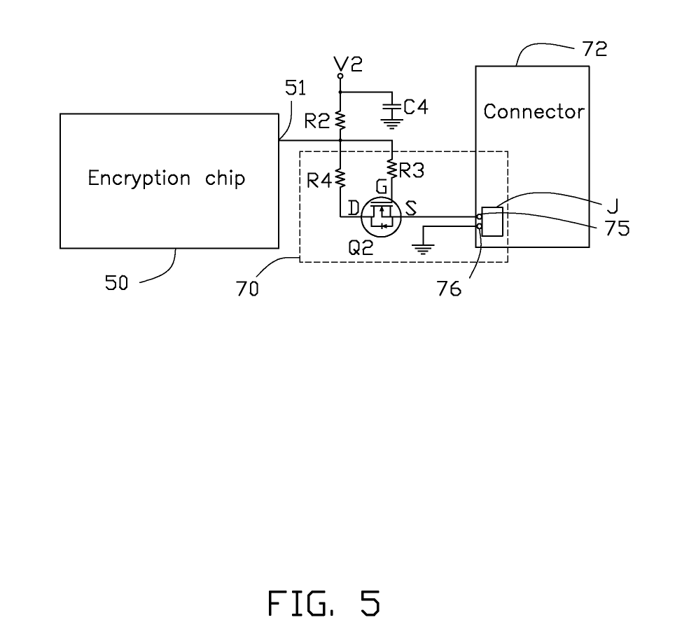

FIG. 5 illustrates an embodiment of the power shielding module 70. The encryption chip 50 comprises a power input terminal 51 electrically coupled to a second power supply V2 through a resistor R2. The second power supply V2 is electrically coupled the ground through a capacitor C4. The power shielding module 70 comprises a second electronic switch Q2, a connector 72, and two resistors R3 and R4. The connector 72 comprises a first terminal 75 and a second terminal 76. The second electronic switch Q2 comprises a first terminal G electrically coupled to the power input terminal 51 of the encryption chip 50 through the resistor R3, a second terminal D electrically coupled to the power input terminal 51 through the resistor R4, and a third terminal S electrically coupled to the first terminal 75 of the connector 72. The second terminal 76 of the connector 72 is electrically coupled to the ground. In at least one embodiment, the connector 72 is installed on the hard disk device 100, the first terminal 75 and the second terminal 76 are two idle pins.

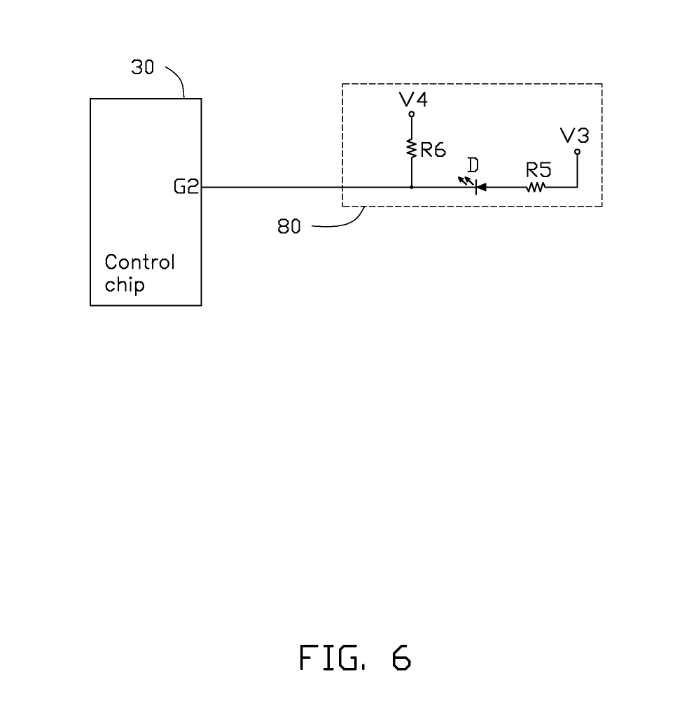

FIG. 6 illustrates an embodiment of the display module 80. The control chip 30 comprises a second pin G2. The display module 80 comprises a light emitting diode D and two resistors R5 and R6. An anode of the light emitting diode D is electrically coupled to a third power supply V3 through the resistor R5, and a cathode of the light emitting diode D is electrically coupled to a fourth power supply V4 through the resistor R6. The cathode of the light emitting diode D is further electrically coupled to the second pin G2. In at least one embodiment, voltage of the third power supply V3 is equal to voltage of the fourth power supply V4.

The hard disk drive 100 can be used as a master hard disk drive, to allow the CPU 400 to read operating system codes from the storage module 20, when the electronic device 1000 is booted. The hard disk drive 100 can further be used as a slave hard disk drive. If the hard disk drive 100 is used as the slave hard disk drive, the operating system codes are not saved in the storage module 20, or the operating system codes are saved in the storage module 20, but the CPU 400 does not read the operating system codes from the storage module 20, when the electronic device 1000 is booted.

When the hard disk drive 100 is used as the master hard disk drive, and the electronic device 1000 is powered on, BIOS codes stored in the BIOS chip 200 is downloaded to the memory 300 by the CPU 400. The CPU 400 executes the basic input output system codes of the memory 300. During the process of executing the BIOS codes, the CPU 400 performs power on self test codes for testing whether some of the key hardware are on the main board 1100 and operate properly. After completing of the power on self test, the display device 1200 displays a BIOS display interface, and the BIOS display interface displays configuration information of the CPU 400, the memory 300, and the hard disk device 100. The CPU 400 accesses the storage module 20 through the control chip 30, to read the operating system codes of the storage module 20. The control chip 30 controls the BIOS display interface to prompts the user to enter a password, and outputs the password to the encryption chip 50. The password is encrypted by the encryption chip 50 to generate an encryption password, and the encryption password is transferred to the control chip 30.

When the control chip 30 receives the encryption password from the encryption chip 50 at the first time, the first received encryption password is set as a reference password by the control chip 30 and the reference password is saved. The control chip 30 enables the CPU 400 to read the operating system codes from the storage module 20. The CPU 400 downloads the operating system codes to the memory 300 and executes the operating system codes in the memory 300. After the electronic device 1000 being booted, the display device 1200 displays an OS display interface.

When the control chip 30 receives the encryption password of the encryption chip 50 subsequently, the control chip 30 compares the subsequent received encryption password with the reference password. When the control chip 30 determines that the subsequent received encryption password is the same as the reference password, the control chip 30 allows the CPU 400 to read the operating system codes of the storage module 20. When the control chip 30 determines that the subsequent encryption password is different from the reference password, the control chip 30 does not enable the CPU 400 to read the operating system code of the storage module 20, controls the OS display interface of the display device 1200 to prompt the user to enter a password, and outputs the password to the encryption chip 50.

When the control chip 30 determines that a plurality of subsequent continuously received encryption passwords are different from the reference password, the first pin G1 of the control chip 30 outputs a low level signal, such as logic 0, to the first terminal G of the first electronic switch Q1. The first electronic switch Q1 turn off, the first power supply V1 does not supply power to the storage module 20, and the hard disk device 100 does not work.

In at least one embodiment, when the control chip 30 determines that three subsequent continuously received encryption passwords are different from the reference password, the first power supply V1 does not supply power to the storage module 20, and the hard disk device 100 does not work. The first pin G1 of the control chip 30 is defaulted to output high level signal, such as logic 1, the first electronic switch turn on, and the first power supply V1 supplies power to the hard disk device 100 through the first electronic switch Q1.

When the hard disk drive 100 is used as the slave hard disk drive, and the electronic device 1000 finishing booting, an OS display interface is displayed on the display device 1200. The CPU 400 accesses the storage module 20 through the control chip 30, to read the storage module 20. The control chip 30 controls the OS display interface to prompts the user to enter a password, and outputs the password is transferred to the encryption chip 50. The password is encrypted by the encryption chip 50 to generate an encryption password, and the encryption password is transferred to the control chip 30.

When the control chip 30 first receives the encryption password from the encryption chip 50 at the first time, the first received encryption password is set as a reference password by the control chip 50 and the reference password is saved. The control chip 30 enables the CPU 400 to read the storage module 20.

When the control chip 30 receives the encryption password of the encryption chip 50 subsequently, the control chip 30 compares the subsequent received encryption password with the reference password. When the control chip 30 determines that the subsequent received encryption password is the same as the reference password, the control chip 30 allows the CPU 400 to read the storage module 20. When the control chip 30 determines that the subsequent encryption password and the reference password is different from the reference password, the control chip 30 does not enable the CPU 400 to read the storage module 20, controls the OS display interface of the display device 1200 to prompt the user to enter a password, and outputs the password to the encryption chip 50.

When the control chip 30 determines that a plurality of subsequent continuously received encryption passwords are different from the reference password, the first pin G1 of the control chip 30 outputs a low level signal, such as logic 0, to the first terminal G of the first electronic switch Q1. The first electronic switch Q1 turn off, the first power supply V1 does not supply power to the storage module 20, and the hard disk device 100 does not work.

If the hard disk device 100 is used as the master hard disk drive, the CPU 400 accesses the storage module 20 at the first time in the basic input output system, and the display interface 90 displayed on the display device 1200 is a BIOS display interface. If the hard disk device 100 is used as the slave hard disk drive, the CPU 400 accesses the storage module 20 at the first time in the operating system, and the display interface 90 displayed on the display device 1200 is an OS display interface.

When the hard disk device 100 does not need to be encrypted, the first terminal 75 is electrically coupled to the second terminal 76 through a jumper J. The power input terminal 51 of the encryption chip 50 is electrically coupled to the ground through the resistor R4, the second electronic switch Q2, the first terminal 75, the jumper J, and the second terminal 76. The encryption chip 50 does not operate, and the encryption function of the hard disk device 100 is shield. The CPU 400 can access the storage module 20 without the user entering password. In other embodiments, the first terminal 75 is electrically coupled to the second terminal 76 by welding, and the jumper J can be omitted.

When the control chip 30 detects that the encryption chip 50 operates, the second pin G2 of the control chip 30 outputs a low level signal, the light emitting diode D is lit, to indicate the hard disk device 100 is in an encrypted state. When the control chip 30 detects that the encryption chip 50 does not operate, the second pin G2 of the control chip 30 outputs a high level signal, the light emitting diode D is not lit, to indicate the hard disk device 100 is not in the encrypted state.

In at least one embodiment, each of the first electronic switch Q1 and the second electronic switch Q2 is an n-channel metal-oxide semiconductor field-effect transistor (NMOSFET). The first terminal G, the second terminal S, and the third terminal D of the electronic switch Q1 are respectively corresponding to the gate, the source, and the drain of the NMOSFET. The first terminal G, the second terminal S, and the third terminal D of the electronic switch Q2 are respectively corresponding to the gate, the source, and the drain of the NMOSFET. In other embodiments, each of the first electronic switch Q1 and the second electronic switch Q2 can be an NPN-type bipolar junction transistor or other suitable switch having similar functions.

Even though numerous characteristics and advantages of the embodiments have been set forth in the foregoing description, together with details of the structure and function of the embodiments, the present disclosure is illustrative only, and changes may be made in detail, including in the matters of shape, size, and arrangement of parts within the principles of the embodiments to the full extent indicated by the broad general meaning of the terms in which the appended claims are expressed.

What is claimed is:

1. A hard disk device comprising:
a storage module;
a power switching module configured to provide power to the storage module;
a control chip electrically coupled to the storage module through the power switching module;
an encryption chip electrically coupled to the control chip; and
wherein the control chip is configured to control a display interface, to prompt a user to input a password, and output the password to the encryption chip, in even that a central processing unit (CPU) accesses the storage module through the control chip, the password is encrypted to generate an encrypted password by the encryption chip, and the encrypted password is transferred to the control chip;
wherein in event that the control chip receives the encrypted password at a first time, the control chip sets the first received encryption password as a reference password, saves the reference password, and enables the CPU accesses the storage module;
wherein in event that the control chip receives the encrypted password, the control chip determines whether the subsequent received encrypted password is the same as the reference password, if the control chip determines that the subsequent received encrypted password is the same as the reference password, the control chip allows the CPU to access the storage module, if the control chip determines that the subsequent encrypted password is different from the reference password, the control chip does not enable the CPU to access the storage module, and instead, the control chip controls the display interface to prompt the user to enter a password and outputs the password to the encryption chip;
wherein in event that the control chip determines that a plurality of subsequent continuously received encrypted passwords are different from the reference password, the control chip controls the power switching module not to power the storage module.

2. The hard disk device of claim 1, wherein the control chip comprises a first pin, the power switching module comprises a first electronic switch comprising a first terminal, a second terminal, and a third terminal, the first pin of the control chip is electrically coupled to the first terminal of the first electronic switch, the second terminal of the first electronic switch is electrically coupled to a first power supply, the third terminal of the first electronic switch is electrically coupled to the storage module, when the first pin of the control chip outputs a first signal, the first electronic switch is turned on, the first power supply powers the storage module through the first electronic switch, when the control chip determines that the plurality of subsequent continuously received encrypted password are different from the reference password, the first pin of the control chip outputs a second signal, the first electronic switch is turned off, the first power supply does not power the storage module.

3. The hard disk device of claim 2, wherein the first signal is a low level signal, the second signal is a high level signal, the first electronic switch is an n-channel metal-oxide semiconductor field-effect transistor (NMOSFET) or a NPN-type bipolar junction transistor, the first electronic switch comprises a first terminal, a second terminal, and a third terminal respectively corresponding to the gate, the source, and the drain of the NMOSFET.

4. The hard disk device of claim 1, further comprising a shielding module, the encryption chip comprises a power input terminal electrically coupled to the shielding module, the power input terminal of the encryption chip is further electrically coupled to a second power module through a first resistor, when the shielding module operates, voltage of the power input terminal of the encryption chip is pulled down by the shielding module, and the encryption chip does not operate.

5. The hard disk device of claim 4, wherein the shielding module comprises a second electronic switch, a connector, a second resistor, and a third resistor, the connector comprises a first terminal and a second terminal, the second electronic switch comprises a first terminal electrically coupled to the power input terminal of the encryption chip through the second resistor, a second terminal electrically coupled to the power input terminal of the encryption chip through the third resistor, and a third terminal electrically coupled to the first terminal of the connector, the second terminal of the connector is electrically coupled to a ground, when the first terminal of the connector is electrically coupled to the second terminal of the connector, the power input terminal of the encryption chip is electrically coupled to the ground through the third resistor, the second electronic switch, the first terminal of the connector, and the second terminal of the connector.

6. The hard disk device of claim 4, wherein the second electronic switch is an n-channel metal-oxide semiconductor field-effect transistor (NMOSFET) or a NPN-type bipolar junction transistor, the second electronic switch comprises a first terminal, a second terminal, and a third terminal respectively corresponding to the gate, the source, and the drain of the NMOSFET.

7. The hard disk device of claim 1, further comprising a display module, wherein the display module comprises a light emitting diode, the control chip further comprises a second pin, the light emitting diode comprises an anode electrically coupled to a third power supply and a cathode electrically coupled to the second pin of the control chip, when the control chip detects that the encryption chip operates, the second pin of the control chip outputs a low level signal, the light emitting diode is lit; when the control chip detects that the encryption chip does not operate, the second pin of the control chip outputs a high level signal, the light emitting diode is not lit.

8. An electronic device, comprising:
a central processing unit (CPU); and
a hard disk device comprising:
a storage module;
a power switching module configured to provide power the storage module;
a control chip electrically coupled to the storage module through the power switching module;
an encryption chip electrically coupled to the control chip; and
wherein the control chip is configured to control a display interface to prompt a user to input a password, and output the password to the encryption chip, in even that the CPU accesses the storage module through the control chip, the password is encrypted to generate an encrypted password by the encryption chip, and the encrypted password is transferred to the control chip;
wherein in event that the control chip receives the encrypted password at a first time, the control chip sets the first received encryption password as a reference password, save the reference password, and enables the CPU access the storage module;
wherein in event that the control chip receives the encrypted password, the control chip determines whether the subsequent received encrypted password is the same as the reference password, if the control chip determines that the subsequent received encrypted password is the same as the reference password, the control chip allows the CPU to access the storage module, if the control chip determines that the subsequent encrypted password is different from the reference password, the control chip does not enable the CPU to access the storage module, and instead, the control chip controls the display interface to prompt the user to enter a password, and outputs the password to the encryption chip;
wherein in event that the control chip determines that a plurality of subsequent continuously received encrypted passwords are different from the reference password, the control chip controls the power switching module not to power the storage module.

9. The electronic device of claim 8, wherein the control chip comprises a first pin, the power switching module comprises a first electronic switch comprising a first terminal, a second terminal, and a third terminal, the first pin of the control chip is electrically coupled to the first terminal of the first electronic switch, the second terminal of the first electronic switch is electrically coupled to a first power supply, the third terminal of the first electronic switch is electrically coupled to the storage module, when the first pin of the control chip outputs a first signal, the first electronic switch is turned on, the first power supply powers the storage module through the first electronic switch, when the control chip determines that the plurality of subsequent continuously received encrypted password are different from the reference password, the first pin of the control chip outputs a second signal, the first electronic switch is turned off, the first power supply does not power the storage module.

10. The electronic device of claim 9, wherein the first signal is a low level signal, the second signal is a high level signal, the first electronic switch is an n-channel metal-oxide semiconductor field-effect transistor (NMOSFET) or a NPN-type bipolar junction transistor, the first electronic switch comprises a first terminal, a second terminal, and a third terminal respectively corresponding to the gate, the source, and the drain of the NMOSFET.

11. The electronic device of claim 8, wherein the hard disk device further comprising a shielding module, the encryption chip comprises a power input terminal electrically coupled to the shielding module, the power input terminal of the encryption chip is further electrically coupled to a second power module through a first resistor, when the shielding module operates, the voltage of the power input terminal of the encryption chip is pulled down by the shielding module, and the encryption chip does not operate.

12. The electronic device of claim 11, wherein the shielding module comprises a second electronic switch, a connector, a second resistor, and a third resistor the connector comprises a first terminal and a second terminal, the second electronic switch comprises a first terminal electrically coupled to the power input terminal of the encryption chip through the second resistor, a second terminal electronically coupled to the power input terminal of the encryption chip through the third resistor, and a third terminal electrically coupled to the first terminal of the connector, the second terminal of the connector is electrically coupled to a ground, when the first terminal of the connector is electrically coupled to the second terminal of the connector, the power input terminal of the encryption chip is electrically coupled to the ground through the third resistor, the second electronic switch, the first terminal of the connector, and the second terminal of the connector.

13. The electronic device of claim 11, wherein the second electronic switch is an n-channel metal-oxide semiconductor field-effect transistor (NMOSFET) or a NPN-type bipolar junction transistor, the second electronic switch comprises a first terminal, a second terminal, and a third terminal respectively corresponding to the gate, the source, and the drain of the NMOSFET.

14. The electronic device of claim 8, further comprising a display module, wherein the display module comprises a light emitting diode, the control chip further comprises a second pin, the light emitting diode comprises an anode electrically coupled to a third power supply and a cathode electrically coupled to the second pin of the control chip, when the control chip detects that the encryption chip operates, the second pin of the control chip outputs a low level signal, the light emitting diode is lit; when the control chip detects that the encryption chip does not operate, the second pin of the control chip outputs a high level signal, the light emitting diode is not lit.
